(19) United States
(12) Patent Application Publication
(10) Pub. No.: US 2019/0258203 A1
(43) Pub. Date: Aug. 22, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/114,801

(22) Filed: Aug. 28, 2018

(30) Foreign Application Priority Data
Feb. 21, 2018 (JP) 2018-028975

(51) Int. Cl. G03H 1/02; G03H 1/00; G03H 1/22

(52) U.S. Cl. CPC G03H 1/02; G03H 1/0005; G03H 2001/2226; G03H 2001/2236; G03H 1/2205

(57) ABSTRACT

An information processing apparatus includes a controller that changes an outer edge of an image formed in air over time.

### CROSS-REFERENCE TO RELATED APPLICATIONS

This application is based on and claims priority under 35 USC 119 from Japanese Patent Application No. 2018-028975 filed Feb. 21, 2018.

### BACKGROUND

### Technical Field

The present invention relates to an information processing apparatus and a non-transitory computer readable medium.

### Related Art

Technology for causing light beams to intersect in the air and forming an image at the point of intersection has been available. An image displayed by this type of technology is also called an aerial image.

At present, it is assumed to use aerial images as digital advertisement or operation panels. However, it is expected that scenes for using aerial images will increase more and more in the future.

### SUMMARY

According to an aspect of the invention, there is provided an information processing apparatus including a controller that changes an outer edge of an image formed in air over time.

### BRIEF DESCRIPTION OF THE DRAWINGS

Exemplary embodiments of the present invention will be described in detail based on the following figures, wherein:

FIG. 1 is a diagram describing the schematic configuration of an aerial image forming system according to an exemplary embodiment;

FIGS. 2A to 2C are diagrams describing the positional relationship between two aerial images, that is, FIG. 2A is a front view (XZ plane) of the relationship, FIG. 2B is a side view (YZ plane) of the relationship, and FIG. 2C is a top view (XY plane) of the relationship;

FIGS. 3A and 3B are diagrams of the principle of an aerial image forming apparatus that forms an aerial image by transmitting light output from a display device through a dedicated optical plate, that is, FIG. 3A illustrates the positional relationship between each member and an aerial image, and FIG. 3B illustrates part of the cross-sectional structure of the optical plate;

FIG. 4 is a diagram of the principle of an aerial image forming apparatus that forms a three-dimensional image as an aerial image;

FIGS. 5A and 5B are diagrams of the principle of an aerial image forming apparatus that forms an aerial image using a micro-mirror array with a structure where tiny square holes constituting a dihedral corner reflector are arranged at regular intervals in a plane, that is, FIG. 5A illustrates the positional relationship between each member and an aerial image, and FIG. 5B is an enlarged view of a portion of the micro-mirror array;

FIG. 6 is a diagram of the principle of an aerial image forming apparatus using a beam splitter and a retroreflective sheet;

FIG. 7 is a diagram of the principle of an aerial image forming apparatus that forms an aerial image as a set of plasma emitters;

FIG. 8 is a diagram describing an example of the hardware configuration of an image control apparatus according to the exemplary embodiment;

FIG. 9 is a diagram describing an example of the functional configuration of the image control apparatus according to the exemplary embodiment;

FIG. 10 is a flowchart describing the overview of a processing operation executed by the image control apparatus according to the exemplary embodiment;

FIGS. 11A and 11B are diagrams describing an example where a size that defines the outer edge of an aerial image changes over time, that is, FIG. 11A illustrates an example where the size of an aerial image changes to be larger over time, and FIG. 11B illustrates an example where the size of an aerial image changes to be smaller over time;

FIGS. 12A and 12B are diagrams describing another example where a size that defines the outer edge of an aerial image changes over time, that is, FIG. 12A illustrates an example where the size of an aerial image changes to be larger over time, and FIG. 12B illustrates an example where the size of an aerial image changes to be smaller over time;

FIGS. 13A and 13B are diagrams describing another example where a size that defines the outer edge of an aerial image changes over time, that is, FIG. 13A illustrates an example where the size of an aerial image changes to be larger over time, and FIG. 13B illustrates an example where the size of an aerial image changes to be smaller over time;

FIGS. 14A and 14B are diagrams describing an example where the form of a target reproduced by an aerial image changes over time, that is, FIG. 14A illustrates an example where the size of an aerial image changes to be larger over time, and FIG. 14B illustrates an example where the size of an aerial image changes to be smaller over time;

FIGS. 15A and 15B are diagrams describing another example where the form of a target reproduced by an aerial image changes over time, that is, FIG. 15A illustrates an example where the size of an aerial image changes to be larger over time, and FIG. 15B illustrates an example where the size of an aerial image changes to be smaller over time;

FIG. 16 is a diagram describing an example where a target reproduced by an aerial image is switched over time, which is specifically an example where the size of an aerial image changes to be larger over time;

FIG. 17 is a diagram describing an example of switching among twelve types of animals reproduced by an aerial image as time elapses;

FIGS. 18A and 18B are diagrams describing an example where the posture of a character reproduced by an aerial image changes over time, that is, FIG. 18A illustrates an example where the size of an aerial image changes to be larger over time, and FIG. 18B illustrates an example where the size of an aerial image does not change;

FIGS. 19A and 19B are diagrams describing an example where a target reproduced by an aerial image changes over time according to a predetermined story, that is, FIG. 19A illustrates an example where the size of an aerial image changes to be larger over time, and FIG. 19B illustrates an example where the size of an aerial image does not change;

FIGS. 20A and 20B are diagrams describing another example where a character reproduced by an aerial image changes over time according to a predetermined story, that is, FIG. 20A illustrates an example where the size of an aerial image changes to be larger over time, and FIG. 20B illustrates an example where the size of an aerial image does not change;

FIG. 21 is a diagram describing an example where the position of an aerial image in space moves over time;

FIG. 22 is a diagram describing another example where the position of an aerial image in space moves over time;

FIG. 23 is a diagram describing another example where the position of an aerial image in space moves over time;

FIG. 24 is a diagram describing another example where the position of an aerial image in space moves over time;

FIG. 25 is a diagram describing an example where the orientation of a target reproduced by an aerial image changes over time;

FIG. 26 is a diagram describing another example where the orientation of a target reproduced by an aerial image changes over time;

FIG. 27 is a diagram describing another example where the orientation of a target reproduced by an aerial image changes over time;

FIGS. 28A and 28B are diagrams describing an example where the details and volume of sound that accompanies an aerial image change over time, that is, FIG. 28A illustrates an example where the details of the sound change over time, and FIG. 28B illustrates an example where the volume of the sound changes over time;

FIG. 29 is a diagram describing a portable information processing apparatus including the aerial image forming apparatus; and

FIG. 30 is a diagram describing a change in the size of an aerial image formed by the portable information processing apparatus over time.

### DETAILED DESCRIPTION

Hereinafter, an exemplary embodiment of the present invention will be described with reference to the drawings.

### Exemplary Embodiment

### Schematic Configuration of Aerial Image Forming System

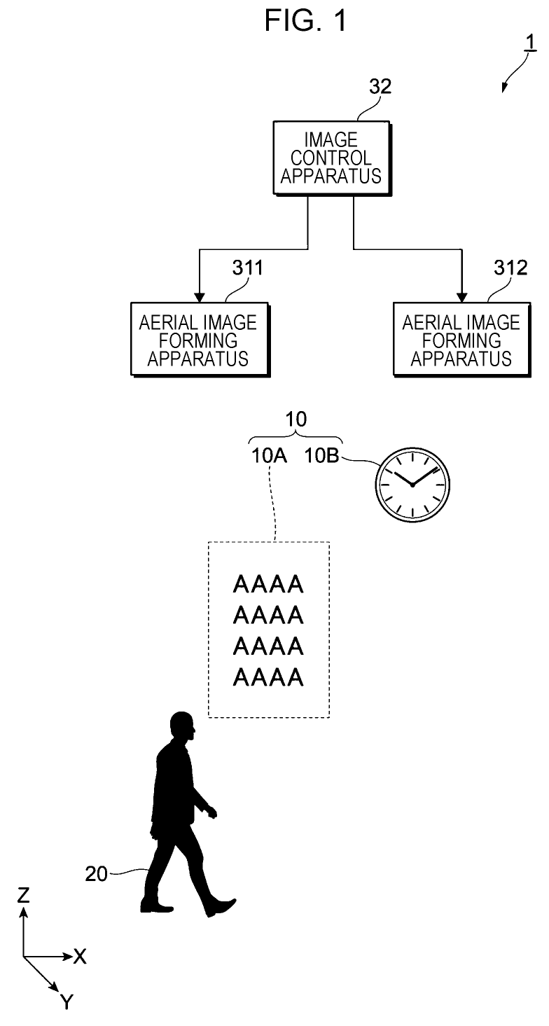

FIG. 1 is a diagram describing the schematic configuration of an aerial image forming system 1 according to the exemplary embodiment. The aerial image forming system 1 is an example of an information processing system.

In the exemplary embodiment, an aerial image 10 is an image formed in the air to reproduce an optical state equivalent to light reflected from an object.

The aerial image 10 is formed to float in the air, enabling a person to go through the aerial image 10.

For example, a screen for guidance or a screen for advertisement is displayed as the aerial image 10. In addition, for example, a screen for operation whose displayed details change in accordance with an operation performed by a person 20 is displayed as the aerial image 10. Needless to say, these screens are examples of display.

Not only a still image, but also a moving image may be displayed as the aerial image 10.

A shape that defines the outer edge of the aerial image 10 is not restricted to a rectangle, and any shape may define the outer edge.

For example, a space where an image of an object reproduced by the aerial image 10 may be the entire space where the aerial image 10 is formed. For example, an image of a button for operation, an image of a person, an image of an animal, an image of a product, and an image of a fruit are examples of the aerial image 10 here.

Although it is assumed that the aerial image 10 illustrated in FIG. 1 has a planar shape, the aerial image 10 may be formed as a stereoscopic shape such as a curved surface, a sphere, or a cube.

The number of aerial images 10 formed in the air may be one or plural.

In FIG. 1, two aerial images 10A and 10B having planar shapes are formed in the air. In the case of the exemplary embodiment, the aerial image 10A is for displaying an advertisement or the like, and the aerial image 10B is for notification of the passage of time.

Therefore, the image “AAAA/AAAA/AAAA/AAAA” is displayed as the aerial image 10A. Here, slashes represent line feeds. A shape that defines the outer edge of the aerial image 10A is a rectangle, as indicated by broken lines.

In contrast, an image of an analog clock is displayed as the aerial image 10. A shape that defines the outer edge of the aerial image 10B is a circle, which defines the outer edge of a clock. In other words, the outer edge of the aerial image 10B is defined by the outer edge of a clock, which corresponds to the displayed details.

In the case of the exemplary embodiment, the shape of the outer edge of the aerial image 10B is defined by the shape of the outer edge of a target reproduced by the aerial image 10B. Therefore, the shape of the outer edge of the aerial image 10B may be given by unevenness.

The aerial image forming system 1 illustrated in FIG. 1 includes aerial image forming apparatuses 311 and 312, which form the aerial images 10A and 10B in the air, and an image control apparatus 32, which controls the aerial image forming apparatuses 311 and 312.

The aerial image forming apparatus 311 is for forming the aerial image 10A, and the aerial image forming apparatus 312 is for forming the aerial image 10B. The aerial image forming apparatuses 311 and 312 are examples of an image forming unit.

The image control apparatus 32 controls display of the aerial images 10A and 10B formed in the air through the aerial image forming apparatuses 311 and 312. For example, the image control apparatus 32 controls the details, size, position, and movement of the aerial images 10A and 10B. The image control apparatus 32 here is an example of a controller and is also an example of an information processing apparatus.

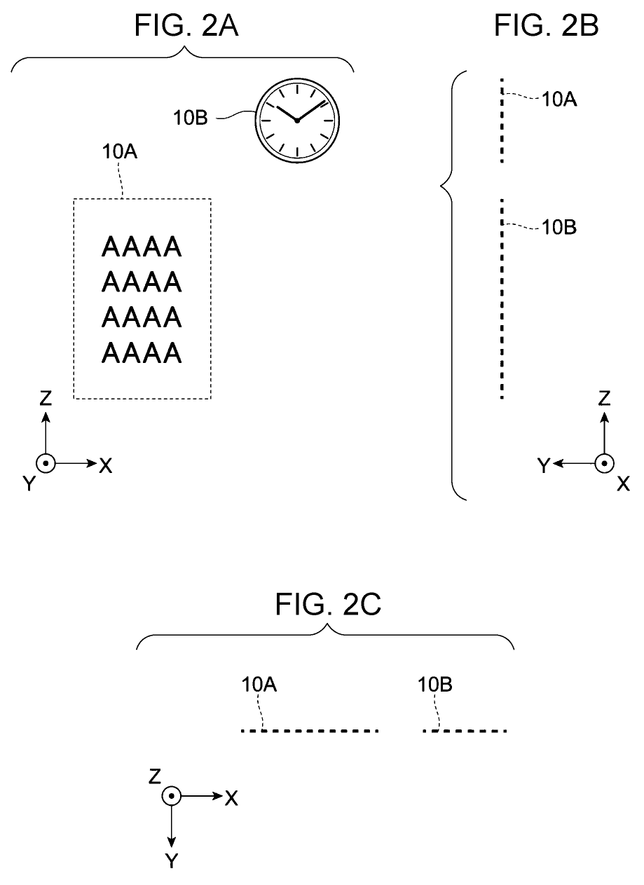

FIGS. 2A to 2C are diagrams describing the positional relationship between the two aerial images 10A and 10B. FIG. 2A is a front view (XZ plane) of the relationship, FIG. 2B is a side view (YZ plane) of the relationship, and FIG. 2C is a top view (XY plane) of the relationship.

As illustrated in FIGS. 2A to 2C, the aerial image 10A and the aerial image 10B are formed as planar images that are spatially separated from each other. Needless to say, because neither of the two aerial images 10A and 10B takes sole possession of the air, the aerial images 10A and 10B may be formed so as to intersect each other or to overlap each other in the same space.

### Example of Aerial Image Forming Apparatus

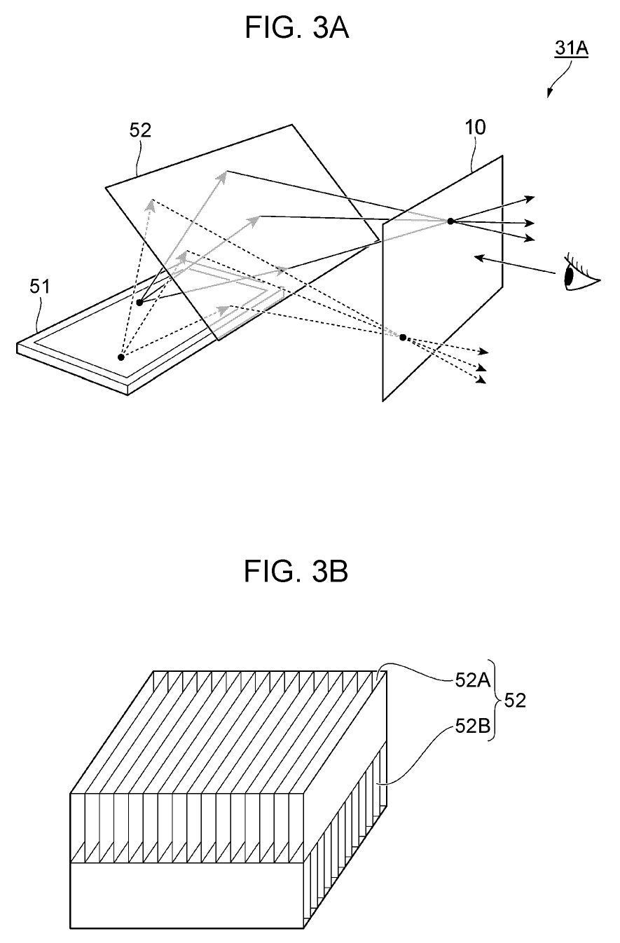

Using FIGS. 3A to 7, principles of forming an aerial image 10 will be described. The principles described below are all known.

FIGS. 3A and 3B are diagrams of the principle of an aerial image forming apparatus 31A, which forms an aerial image 10 by transmitting light output from a display device 51 through a dedicated optical plate 52. FIG. 3A illustrates the positional relationship between each member and an aerial image 10, and FIG. 3B illustrates part of the cross-sectional structure of the optical plate 52. The display device 51 and the optical plate 52 here are examples of optical components.

The optical plate 52 has a structure where two plates are stacked one above the other: in one plate, strip-shaped glasses 52A, whose wall is used as a mirror, are arranged; and in the other plate, strip-shaped glasses 52B are arranged in a direction orthogonal to the glasses 52A.

The optical plate 52 represents an image displayed on the display device 51 in the air by reflecting light output from the display device 51 twice at the strip-shaped glasses 52A and 52B and forming an image in the air. Note that the distance between the display device 51 and the optical plate 52 is equal to the distance between the optical plate 52 and the aerial image 10. In addition, the size of an image displayed on the display device 51 is the same as the size of the aerial image 10. For example, when the display device 51 is an organic electroluminescence (EL) display, the size of the aerial image 10 may be enlarged or reduced by enlarging or reducing the size of an area where light emission of pixels is controlled. The same applies to the case where the display device 51 is a liquid crystal display (LCD).

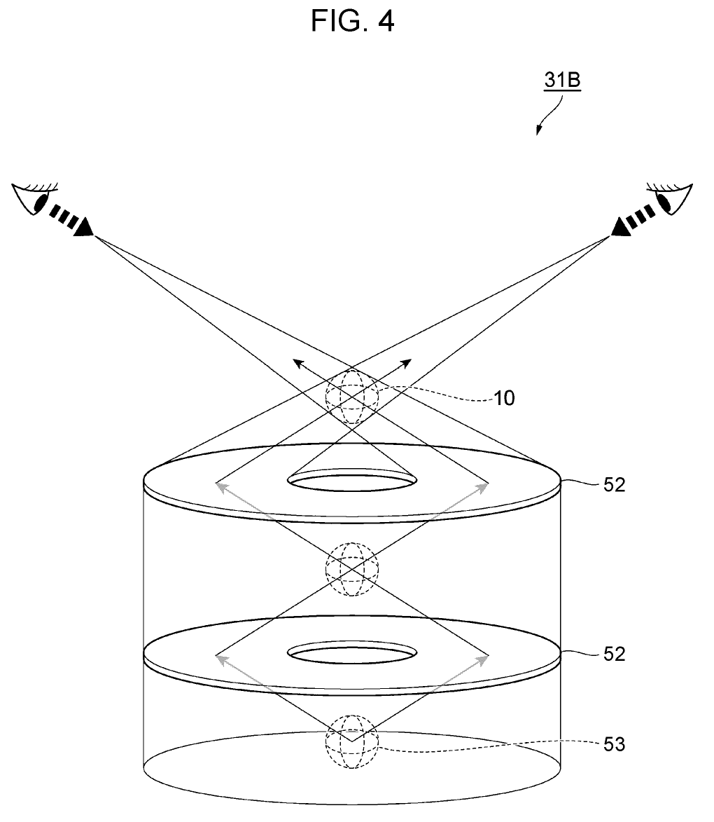

FIG. 4 is a diagram of the principle of an aerial image forming apparatus 31B, which forms a three-dimensional image as an aerial image 10. The aerial image forming apparatus 31B represents a three-dimensional image (aerial image 10) in the air by transmitting light reflected at the surface of an actual object 53 through ring-shaped optical plates 52 twice. Note that it is not necessary to arrange the optical plates 52 in series.

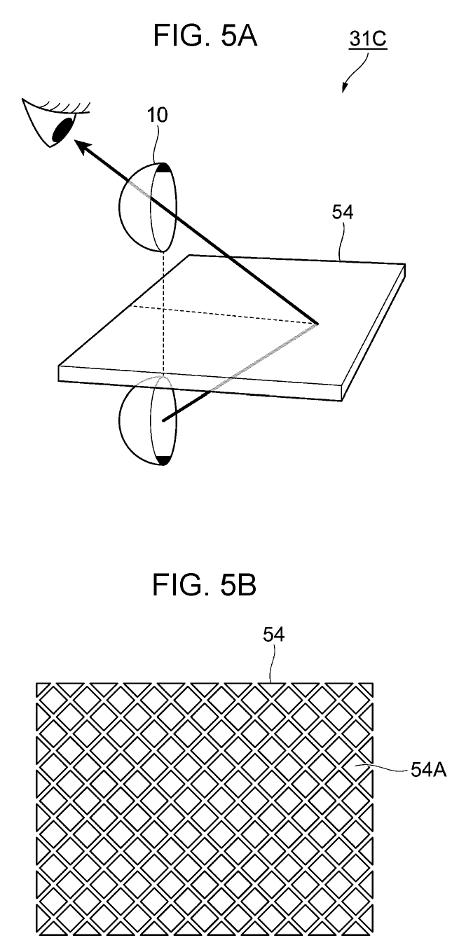

FIGS. 5A and 5B are diagrams of the principle of an aerial image forming apparatus 31C, which forms an aerial image 10 using a micro-mirror array 54 with a structure where tiny square holes 54A constituting a dihedral corner reflector are arranged at regular intervals in the plane. FIG. 5A illustrates the positional relationship between each member and an aerial image 10, and FIG. 5B is an enlarged view of a portion of the micro-mirror array 54. One hole 54A is formed of, for example, a 100-μm square. The micro-mirror array 54 here is an example of an optical component.

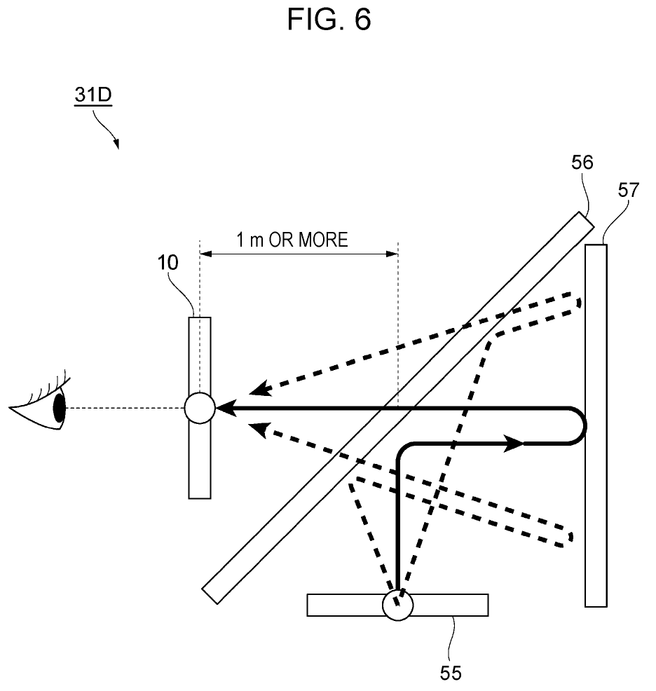

FIG. 6 is a diagram of the principle of an aerial image forming apparatus 31D, which uses a beam splitter 56 and a retroreflective sheet 57. Here, the beam splitter 56 is arranged at an angle of 45 degrees with respect to the display side of a display device 55. In addition, the retroreflective sheet 57 is arranged at an angle of 90 degrees with respect to the display side of the display device 55 in a direction in which a display image is reflected by the beam splitter 56. The display device 55, the beam splitter 56, and the retroreflective sheet 57 are examples of optical components.

In the case of the aerial image forming apparatus 31D, light output from the display device 55 is reflected by the beam splitter 56 to a direction of the retroreflective sheet 57, which is then retroreflected by the retroreflective sheet 57 and is transmitted through the beam splitter 56, thereby forming an image in the air. The aerial image 10 is formed at a position where light forms an image.

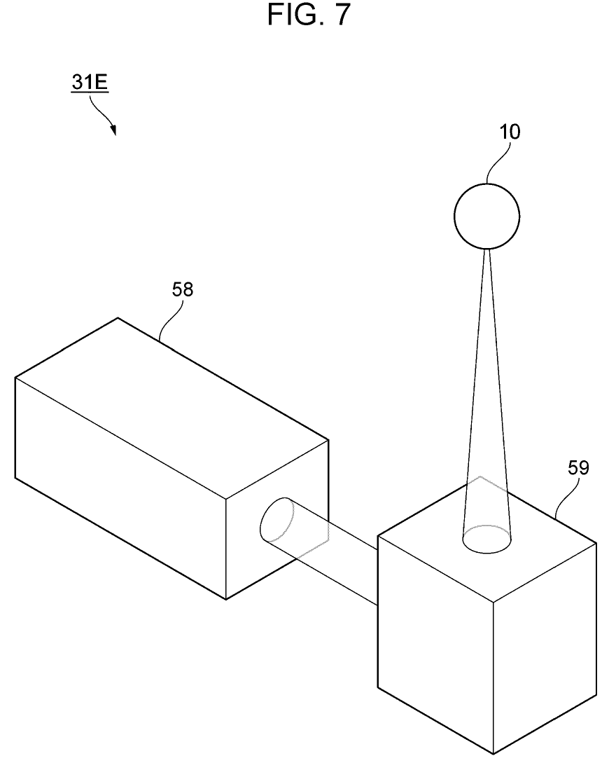

FIG. 7 is a diagram of the principle of an aerial image forming apparatus 31E, which forms an aerial image 10 as a set of plasma emitters.

In the case of the aerial image forming apparatus 31E, an infrared pulse laser 58 outputs pulsed laser light, and an XYZ scanner 59 condenses the pulsed laser light in the air. At this time, gas in the vicinity of the focus instantaneously turns into plasma, and light is emitted. A pulse frequency is, for example, 100 Hz or lower, and a pulse light emission time is in, for example, nanosecond order. The infrared pulse laser 58 and the XYZ scanner 59 here are examples of optical components.

### Configuration of Image Control Apparatus 32

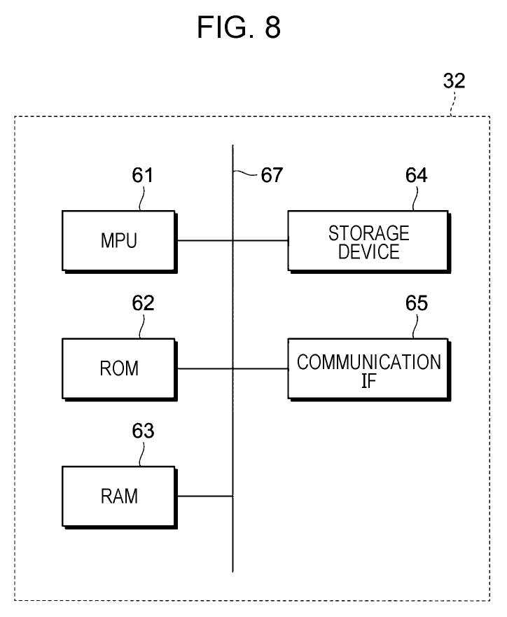

FIG. 8 is a diagram describing an example of the hardware configuration of the image control apparatus 32 according to the exemplary embodiment.

The image control apparatus 32 includes a micro-processing unit (MPU) 61, which provides various functions through firmware and execution of application programs; read-only memory (ROM) 62, which is a storage area that stores firmware and basic input output system (BIOS); and random-access memory (RAM) 63, which is a program execution area. The MPU 61, the ROM 62, and the RAM 63 here are examples of a so-called computer.

In addition, the image control apparatus 32 has a storage device 64, which stores application programs and image data. The storage device 64 is, for example, a rewritable non-volatile storage medium.

In addition, the image control apparatus 32 controls the aerial image forming apparatuses 311 and 312 using a communication interface (IF) 65, and changes the details and size of the aerial images 10A and 10B formed in the air. What is controlled here includes the position and size for forming an aerial image 10. The position here includes not only a two-dimensional position but also a three-dimensional position. The individual units are interconnected through bus 67.

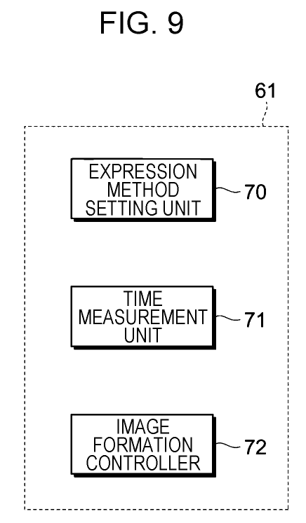

FIG. 9 is a diagram describing an example of the functional configuration of the image control apparatus 32 (see FIG. 8) according to the exemplary embodiment.

Functions illustrated in FIG. 9 are realized through execution of a program by the MPU 61. Note that the functions illustrated in FIG. 9 are used for forming the aerial image 10B (see FIG. 1), which visually expresses the passage of time.

The MPU 61 functions as an expression method setting unit 70, which sets a method of expressing the passage of time, a time measurement unit 71, which measures the time elapsed, and an image formation controller 72, which controls formation of the aerial image 10B.

The expression method setting unit 70 in the exemplary embodiment receives settings entered by operations on operators (not illustrated), such as buttons and switches, or through communication. The details of the received settings are stored in the RAM 63 (see FIG. 8) or the storage device 64 (see FIG. 8).

Examples of the method of expressing the aerial image 10B include the method of gradually enlarging the outer edge of the aerial image 10B over time, and, conversely, the method of gradually reducing the size of the outer edge of the aerial image 10B over time. These methods are examples of a method of changing the outer edge of an aerial image over time.

A settable method of expression is not restricted to enlargement or reduction of the size of the outer edge. Examples of the settable method of expression include the setting on a target reproduced by the aerial image 10B, the setting to change the form over time, and the setting to switch a target reproduced over time.

In addition, multiple settings may be combined. A specific example of the settable method of expression will be described later.

Time measurement done by the time measurement unit 71 is independent of formation of the aerial image 10A. That is, time measurement has no relationship with the presence/absence of the aerial image 10A in the air.

In addition, time measurement done by the time measurement unit 71 is not necessarily in conjunction with formation of the aerial image 10B. Although time measurement may start at the same time as formation of the aerial image 10B, time measurement may start at a time point at which a user or the like gives an instruction to start measurement.

Note that time measurement done by the time measurement unit 71 may not only be measurement of time elapsed since the start of measurement, but also be measurement of the remaining time until a predetermined time point. Measurement of the remaining time may be used in the case where the end time is fixed, such as in the case of a class, a lecture, or a meeting.

The image formation controller 72 outputs image data corresponding to the aerial image 10B (see FIG. 1) to the aerial image forming apparatus 312. The image data output to the aerial image forming apparatus 312 may be, for example, determined in accordance with the settings of the expression method setting unit 70 or may be determined in accordance with the details of an image displayed as the aerial image 10A. For example, the tone and details of the aerial image 10B may be determined to match the tone and details of the aerial image 10A.

### Processing Operation of Image Control Apparatus 32

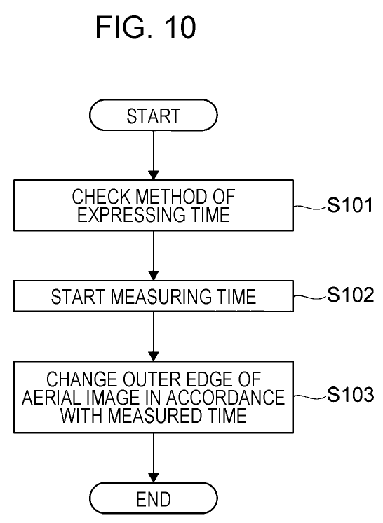

FIG. 10 is a flowchart describing the overview of a processing operation executed by the image control apparatus (see FIG. 8) according to the exemplary embodiment. Because this description is about the overview, details will be different according to the individual form of use. The processing operation illustrated in FIG. 10 is used to form the aerial image 10B for notifying people of the passage of time.

At first, the image control apparatus 32 checks the method of expressing time using the aerial image 10B (step S101). In this processing, preset information may be read, or setting information may be received from a user interface.

Next, the image control apparatus 32 starts measuring time (step S102). Measurement starts in conjunction with the start of formation of the aerial image 10B, for example. In the case where an instruction is given through a user interface to start measurement, time measurement starts from the time point at which the instruction is given.

The image control apparatus 32, which has started the measurement, controls the aerial image forming apparatus 312 such that the outer edge of the aerial image 10B will change in accordance with the measured time (step S103).

### Exemplary Formation of Aerial Image 10B

Hereinafter, exemplary formation of the aerial image 10B involving changes in the outer edge over time will be described.

Although only the aerial image 10B will be described in the following description, another aerial image 10A may be displayed together with the aerial image 10B. At that time, the number of aerial images 10A is not restricted to one. In addition, the number of aerial images 10B formed in the air to notify people of the passage of time is also not restricted to one.

### First Example

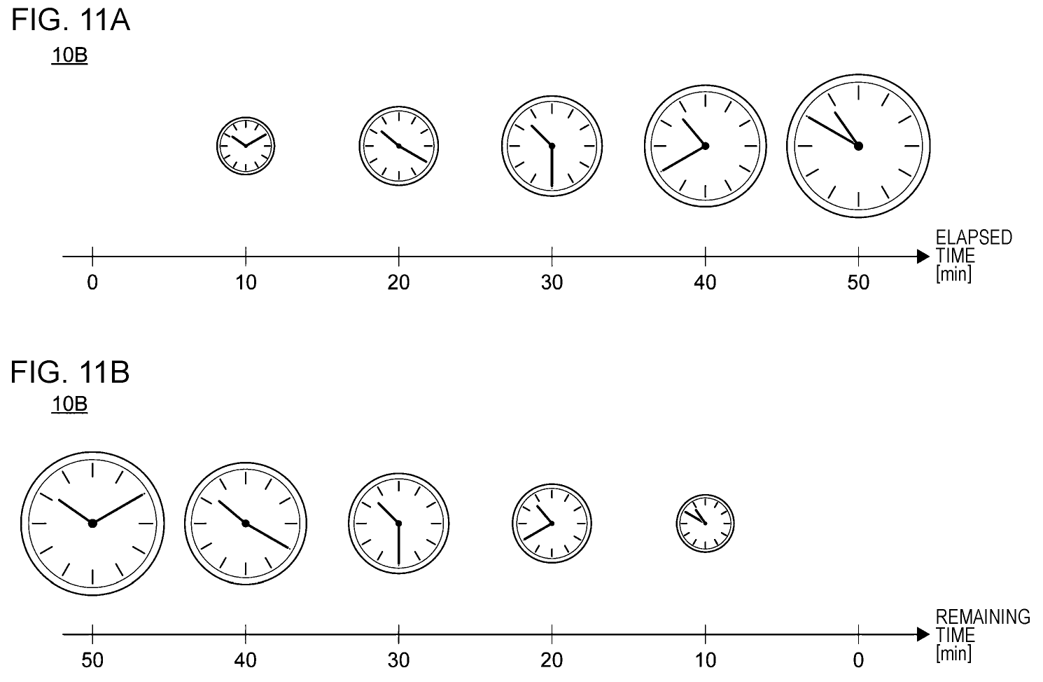

FIGS. 11A and 11B are diagrams describing an example where a size that defines the outer edge of the aerial image 10B changes over time. FIG. 11A illustrates an example where the size of the aerial image 10B changes to be larger over time, and FIG. 11B illustrates an example where the size of the aerial image 10B changes to be smaller over time.

In the case of FIGS. 11A and 11B, the aerial image 10B is an image reproducing an analog clock. The aerial image 10B here may be formed as a planar image or a stereoscopic image in the air.

In the case of FIGS. 11A and 11B, the position of the outer edge of the aerial image 10B coincides with the position of the outer edge of an analog clock. Needless to say, the position of the outer edge of the aerial image 10B may be positioned outside the position of the outer edge of a clock by a margin as long as the outer edge of the aerial image 10B has a shape resembling the outer edge of a clock.

In the exemplary embodiment, a planar image is used in the sense that all pixels constituting the aerial image 10B (including not only two-dimensional elements, but also three-dimensional elements) are positioned on one plane. Needless to say, the image may be expressed in perspective such that an hourglass image will be stereoscopically viewed.

In the exemplary embodiment, a stereoscopic image is used in the sense that three-dimensional elements (so-called voxels) constituting the aerial image 10B are arranged stereoscopically in space. The fact that three-dimensional elements are arranged stereoscopically refers to a state in which elements constituting a stereoscopic image do not fit within one plane.

From changes in the size of the aerial image 10B, the user is able to know the approximate passage of time without looking at the hour hand.

For example, even when the size of the aerial image 10B is so small that it is difficult to check the hour hand, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

In the case of FIGS. 11A and 11B, the size in increments of ten minutes is illustrated; however, the size may be changed at predetermined time intervals (such as one second, five seconds, ten seconds, thirty seconds, one minute, two minutes, etc.).

Note that the aerial image 10B may reproduce a digital clock instead of an analog clock.

### Second Example

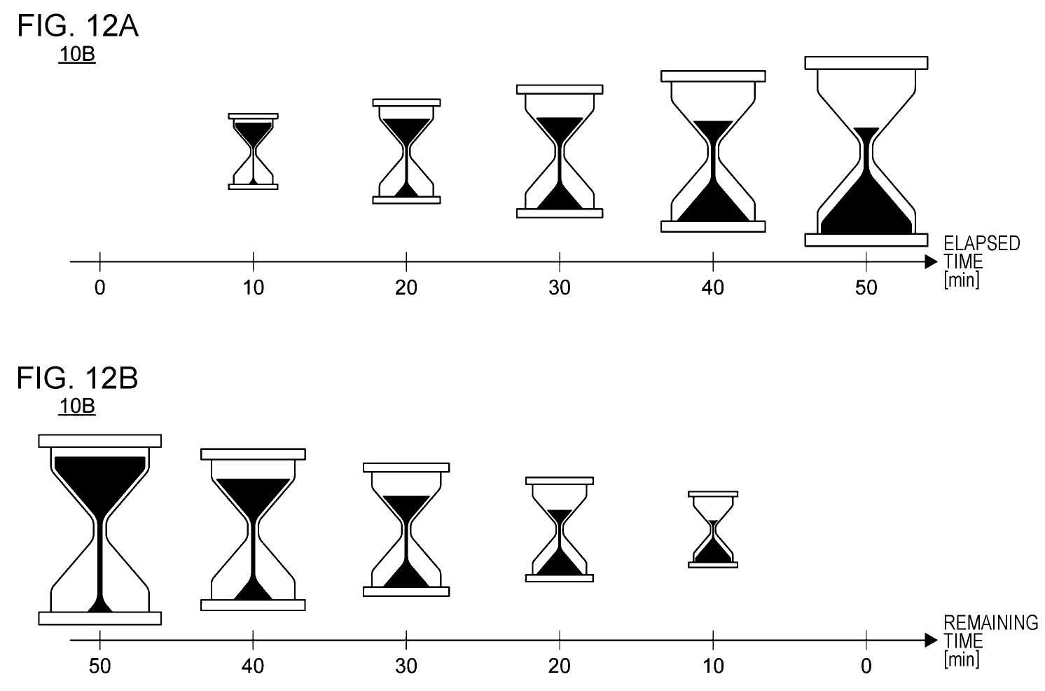

FIGS. 12A and 12B are diagrams describing another example where a size that defines the outer edge of the aerial image 10B changes over time. FIG. 12A illustrates an example where the size of the aerial image 10B changes to be larger over time, and FIG. 12B illustrates an example where the size of the aerial image 10B changes to be smaller over time.

In the case of FIGS. 12A and 12B, the aerial image 10B is an image reproducing an hourglass. The aerial image 10B here may also be formed as a planar image or a stereoscopic image in the air.

In the case of FIGS. 12A and 12B, the outer edge of the aerial image 10B coincides with the outer edge of an hourglass.

From changes in the size of the aerial image 10B, the user is able to know the approximate passage of time without looking at the amount of sand.

For example, even when the size of the aerial image 10B is so small that it is difficult to check the amount of sand, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

In the case of FIGS. 12A and 12B, the size in increments of ten minutes is illustrated; however, the size may be changed at predetermined time intervals (such as one second, five seconds, ten seconds, thirty seconds, one minute, two minutes, etc.).

### Third Example

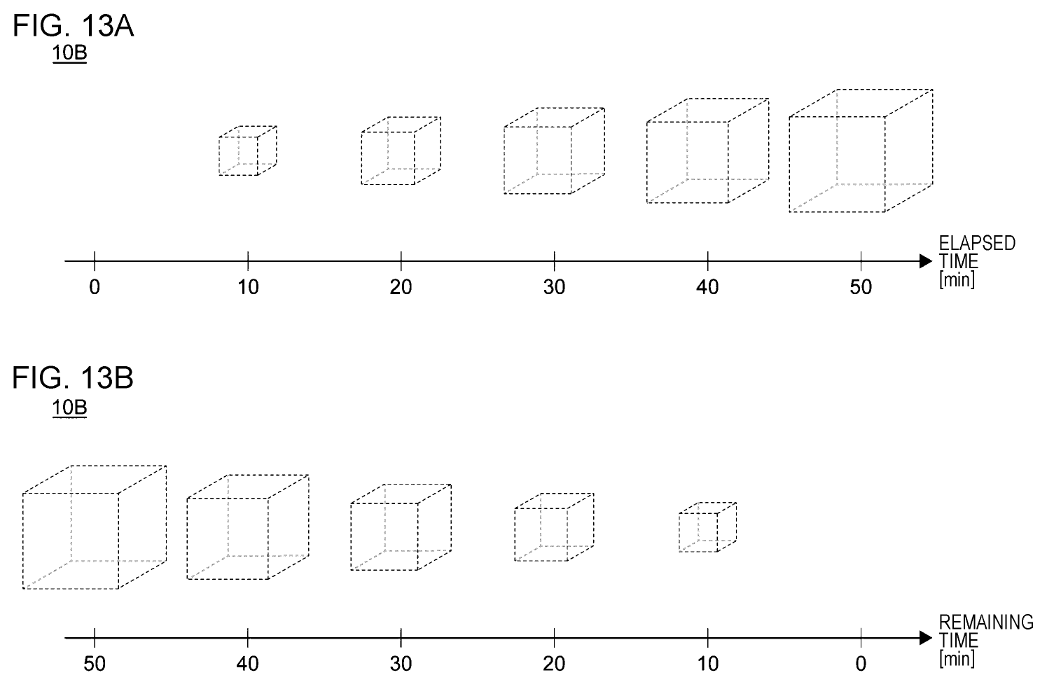

FIGS. 13A and 13B are diagrams describing another example where a size that defines the outer edge of the aerial image 10B changes over time. FIG. 13A illustrates an example where the size of the aerial image 10B changes to be larger over time, and FIG. 13B illustrates an example where the size of the aerial image 10B changes to be smaller over time.

In the case of FIGS. 13A and 13B, the aerial image 10B is an image reproducing a cube (regular hexahedron). The aerial image 10B in the exemplary embodiment may also be formed as a planar image or a stereoscopic image in the air.

Needless to say, a cube is only one example, and an arbitrary shape may be formed.

In this case, the user is also able to know the approximate passage of time from changes in the size of the aerial image 10B.

For example, even when the size of the aerial image 10B is small, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

In the case of FIGS. 13A and 13B, the size in increments of ten minutes is illustrated; however, the size may be changed at predetermined time intervals (such as one second, five seconds, ten seconds, thirty seconds, one minute, two minutes, etc.).

### Fourth Example

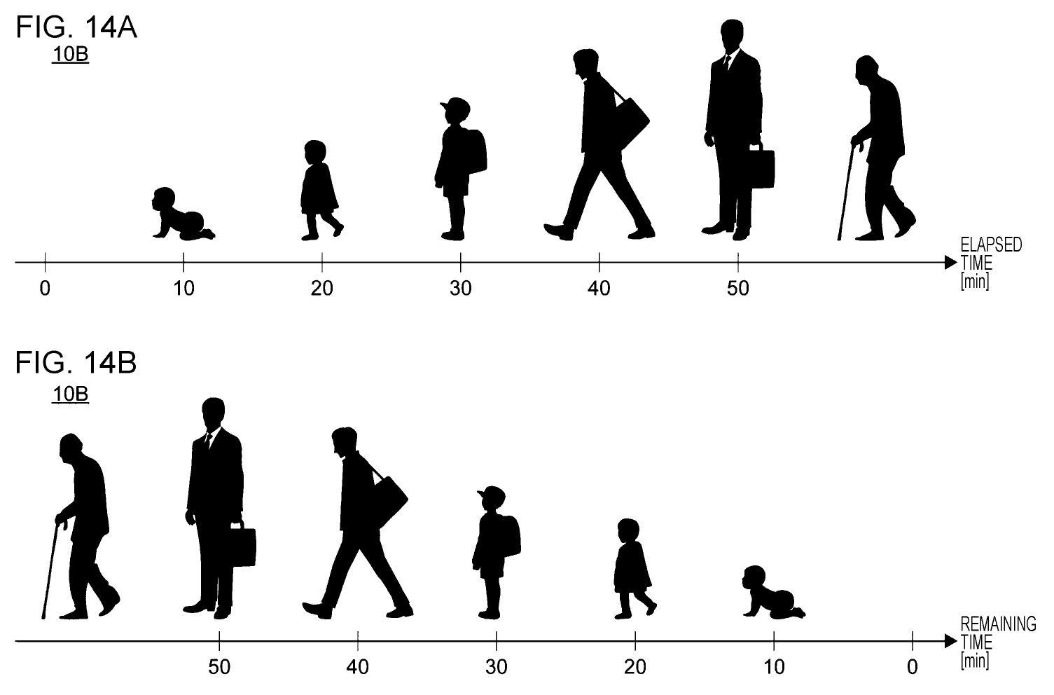

FIGS. 14A and 14B are diagrams describing an example where the form of a target reproduced by the aerial image 10B changes over time. FIG. 14A illustrates an example where the size of the aerial image 10B changes to be larger over time, and FIG. 14B illustrates an example where the size of the aerial image 10B changes to be smaller over time.

In FIGS. 14A and 14B, as examples where the form of a reproduced target changes, the case where a person grows and the case where a person regresses are illustrated.

FIG. 14A expresses a process in which a person grows from baby to infant, child, student, adult, and to elder over time, which is combined with changes in the size of the aerial image 10B.

FIG. 14B expresses a process in which a person regresses from elder to adult, student, child, infant, and to baby over time, which is combined with changes in the size of the aerial image 10B.

Note that the aerial image 10B in the exemplary embodiment may also be formed as a planar image or a stereoscopic image in the air.

In this case, the user is also able to know the approximate passage of time from the size of the aerial image 10B and the stage of growth or from the size of the aerial image 10B and the stage of regression.

For example, even when the size of the aerial image 10B is small, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

In the case of FIGS. 14A and 14B, the size in increments of ten minutes is illustrated; however, the size may be changed at predetermined time intervals (such as one second, five seconds, ten seconds, thirty seconds, one minute, two minutes, etc.).

Note that the size of the aerial image 10B may stay constant, and only the form of the target may be changed. In this case, the user is also able to estimate the approximate passage of time or the remaining time from the stage of growth or the stage of regression.

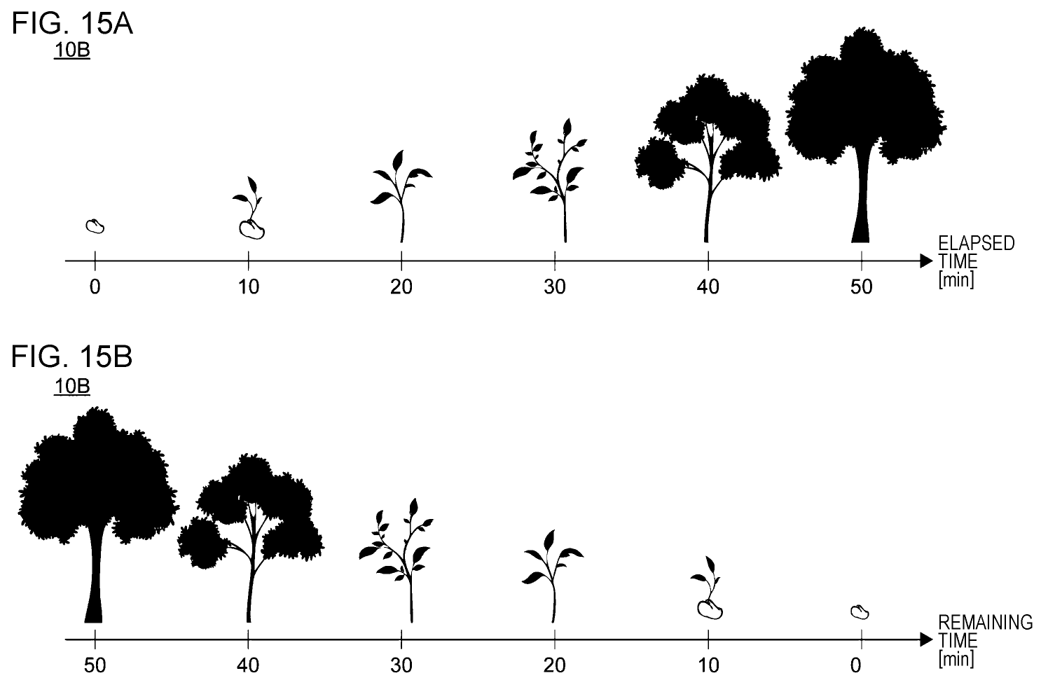

FIGS. 15A and 15B are diagrams describing another example where the form of a target reproduced by the aerial image 10B changes over time. FIG. 15A illustrates an example where the size of the aerial image 10B changes to be larger over time, and FIG. 15B illustrates an example where the size of the aerial image 10B change to be smaller over time.

In FIGS. 15A and 15B, as examples where the form of a reproduced target changes, the case where a tree grows and the case where a tree regresses are illustrated.

FIG. 15A expresses a process in which a tree grows from a seed to seed leaves, a young tree, and to a mature tree over time, which is combined with changes in the size of the aerial image 10B.

FIG. 15B expresses a process in which a tree regresses from a mature tree to a young tree, seed leaves, and to a seed over time, which is combined with changes in the size of the aerial image 10B.

Note that the aerial image 10B in the exemplary embodiment may also be formed as a planar image or a stereoscopic image in the air.

In this case, the user is also able to know the approximate passage of time from the size of the aerial image 10B and the stage of growth or from the size of the aerial image 10B and the stage of regression.

For example, even when the size of the aerial image 10B is small, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

In the case of FIGS. 15A and 15B, the size in increments of ten minutes is illustrated; however, the size may be changed at predetermined time intervals (such as one second, five seconds, ten seconds, thirty seconds, one minute, two minutes, etc.).

Note that the size of the aerial image 10B may stay constant, and only the form of the target may be changed. In this case, the user is also able to estimate the approximate passage of time or the remaining time from the stage of growth or the stage of regression.

Besides the above-mentioned examples, a process in which a character in a game develops or degenerates may be expressed.

In addition, a process in which a fruit grows from a small state to maturity or its opposite process of regression may be expressed.

In addition, a cycle in which green leaves grow bigger, become autumn leaves, and then eventually become withered leaves or a cycle opposite thereto may be expressed.

In the exemplary embodiment, changes in the color or state of leaves serve as examples of a process of growth or a process of regression. Needless to say, these changes may be treated as examples for expressing changes of the seasons.

In this way, changes of one target over time may be evaluated in multiple ways. Fifth Example

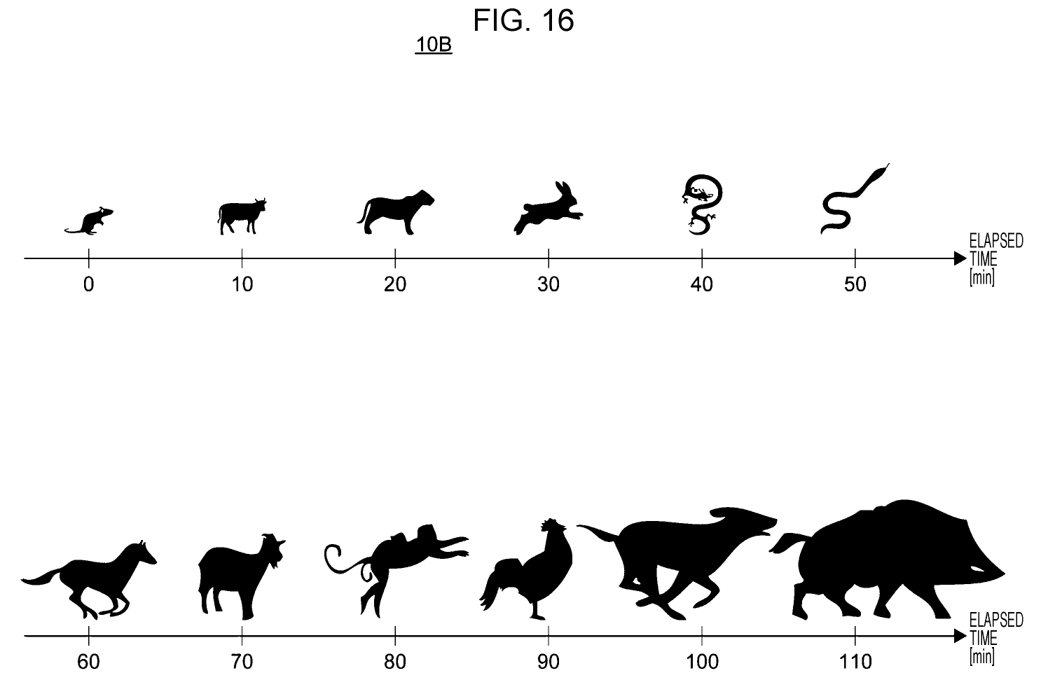

FIG. 16 is a diagram describing an example where a target reproduced by the aerial image 10B is switched over time, which is specifically an example where the size of the aerial image 10B changes to be larger over time.

In FIG. 16, as an example where a reproduced target is switched, an example of sequentially switching among twelve types of animals (including fantasy creatures) is illustrated.

The twelve types of animals, illustrated in FIG. 16, are mouse (0 minutes), cow (10 minutes), tiger (20 minutes), rabbit (30 minutes), dragon (40 minutes), snake (50 minutes), horse (60 minutes), sheep (70 minutes), monkey (80 minutes), bird (90 minutes), dog (100 minutes), and wild boar (110 minutes). These animals are assigned to the individual positions in the case of expressing time and orientation divided into 12 equal parts.

The aerial image 10B in the exemplary embodiment may also be formed as a planar image or a stereoscopic image in the air.

In this case, the user is also able to know the approximate passage of time from the size of the aerial image 10B.

For example, even when the size of the aerial image 10B is small, if the user is aware of the fact that the size of the aerial image 10B gradually changes to be larger, the user knows that the measurement has just started. In contrast, if the user is aware of the fact that the size of the aerial image 10B gradually changes to be smaller, the user knows that the remaining time is short.

Note that the case is not restricted to twelve types of animals, and the size of the aerial image 10B may be constant when the order of appearance of targets being switched is known. In the exemplary embodiment, the size here is defined as the length of the diagonal of a rectangle contacting the outer edge of a reproduced target. The size may be approximate.

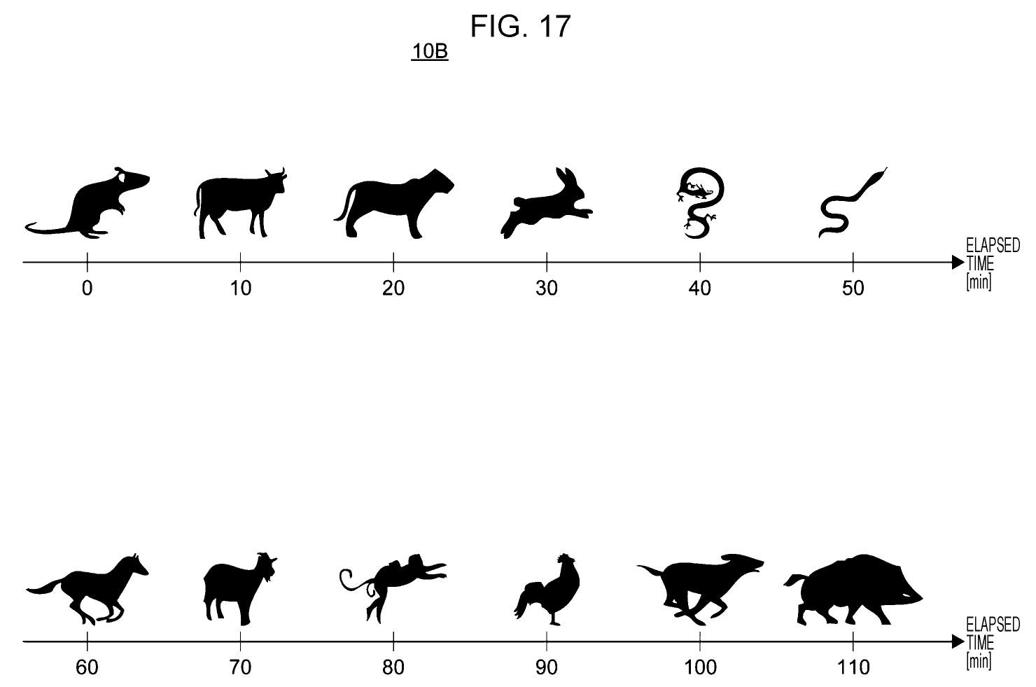

FIG. 17 is a diagram describing an example of switching among twelve types of animals reproduced by the aerial image 10B as time elapses.

In the case of FIG. 17, the approximate time may be understood if the animal reproduced by the aerial image 10B is known.

Although the twelve types of animals are used in the above-described example, a character in a game or the like may be used instead. For example, in the case of a character whose name changes as the character evolves, it is easy to estimate the passage of time by checking a specific character.

### Sixth Example

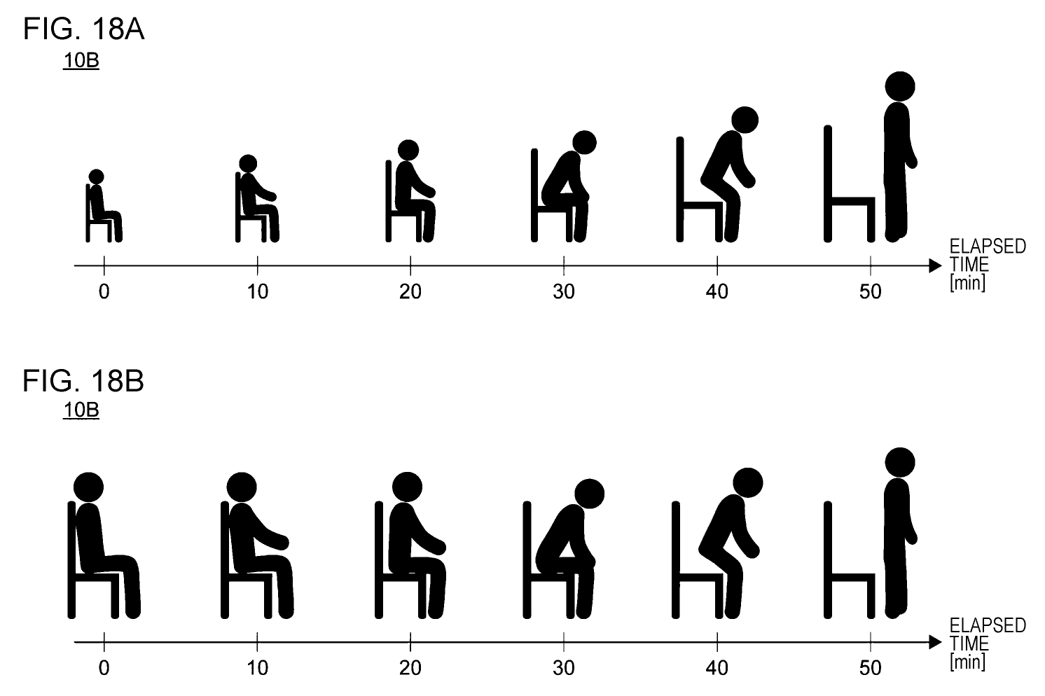

FIGS. 18A and 18B are diagrams describing an example where the posture of a character reproduced by the aerial image 10B changes over time. FIG. l8A illustrates an example where the size of the aerial image 10B changes to be larger over time, and FIG. 18B illustrates an example where the size of the aerial image 10B does not change.

Note that the aerial image 10B in the exemplary embodiment may also be formed as a planar image or a stereoscopic image in the air.

The example illustrated in FIGS. 18A and 18B represents a change in posture from a state where a person sits to a state where the person stands up.

In this case, the user is also able to know the approximate passage of time from changes in the size of the aerial image 10B. In addition, if the order of appearance of changes in posture is known, the user is able to know the approximate passage of time from the changes in posture.

Note that the details of changes in posture in the case where the size does not change are arbitrary if the user is able to guess the time elapsed or the remaining time in accordance with the changes.

In the case of FIG. 18A, the size in increments of ten minutes is illustrated; however, the size may be changed at predetermined time intervals (such as one second, five seconds, ten seconds, thirty seconds, one minute, two minutes, etc.).

### Seventh Example

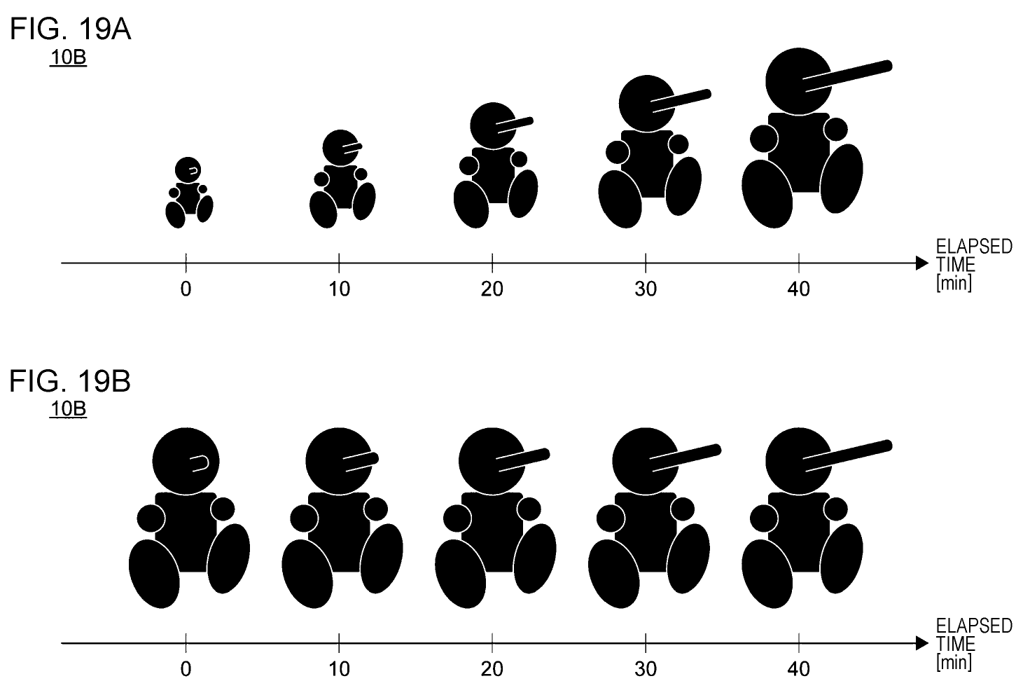

FIGS. 19A and 19B are diagrams describing an example where a target reproduced by the aerial image 10B changes over time according to a predetermined story. FIG. 19A illustrates an example where the size of the aerial image 10B changes to be larger over time, and FIG. 19B illustrates an example where the size of the aerial image 10B does not change.

The aerial image 10B here may also be formed as a planar image or a stereoscopic image in the air.

In the case of FIGS. 19A and 19B, Pinocchio's nose becomes longer as time elapses. In the case of FIGS. 19A and 19B, regardless of changes in size, the user is able to know the approximate passage of time from changes in the length of Pinocchio's nose.

Needless to say, in the case of FIG. 19A, the user is able to know the approximate passage of time from changes in the size of the aerial image 10B even when the user does not know changes in the length of Pinocchio's nose. Although the case where the size of the aerial image 10B gradually changes to be larger as time elapses is illustrated in FIG. 19A, the size of the aerial image 10B may gradually change to be smaller as time elapses, as in the first to fourth examples.

In the case of FIGS. 19A and 19B, the size in increments of ten minutes is illustrated; however, the size (the length of the nose in the case of FIG. 19B) may be changed at predetermined time intervals (such as one second, five seconds, ten seconds, thirty seconds, one minute, two minutes, etc.).

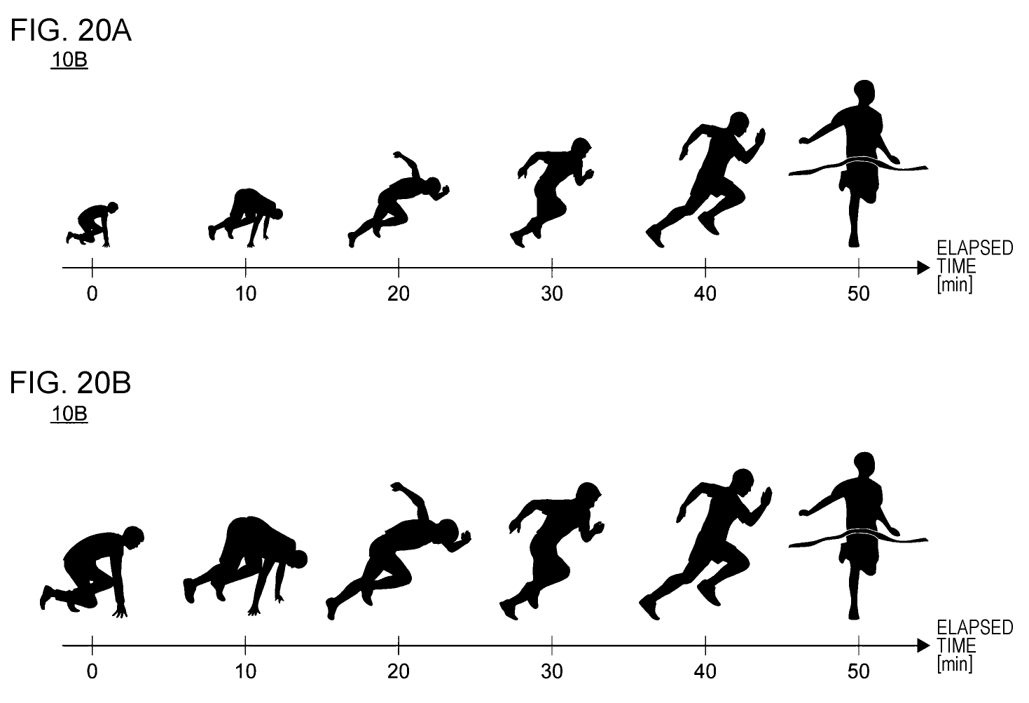

FIGS. 20A and 20B are diagrams describing another example where a target reproduced by the aerial image 10B changes over time according to a predetermined story. FIG. 20A illustrates an example where the size of the aerial image 10B changes to be larger over time, and FIG. 20B illustrates an example where the size of the aerial image 10B does not change.

The aerial image 10B here may also be formed as a planar image or a stereoscopic image in the air.

In the case of FIGS. 20A and 20B, a 100-meter sprint is regarded as a story, and the posture at the start position changes to sprinting, and then to crossing the finish line. In the case of FIGS. 20A and 20B, if the individual stages of the story are understood, the user is able to know the approximate passage of time from changes in posture of the runner, regardless of changes in size.

Needless to say, in the case of FIG. 19A, the user is able to know the approximate passage of time from changes in the size of the aerial image 10B, even when the user does not know changes in posture. Although the case where the size of the aerial image 10B gradually changes to be larger as time elapses is illustrated in FIG. 20A, the size of the aerial image 10B may gradually change to be smaller as time elapses, as in the first to fourth examples.

In the case of FIGS. 20A and 20B, the size in increments of ten minutes is illustrated; however, the size (the posture in the case of FIG. 20B) may be changed at predetermined time intervals (such as one second, five seconds, ten seconds, thirty seconds, one minute, two minutes, etc.).

### Eighth Example

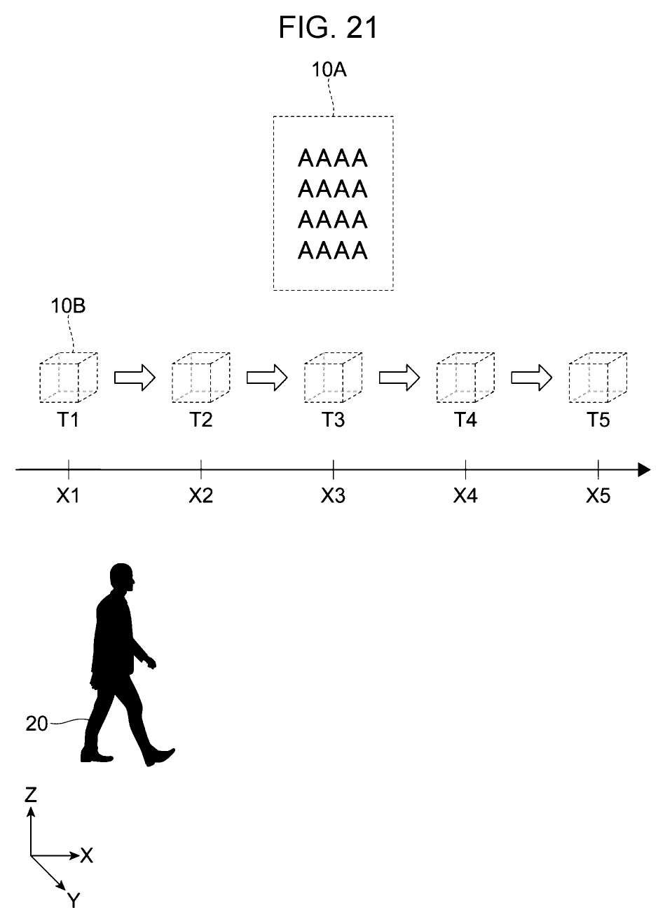

FIG. 21 is a diagram describing an example where the position of the aerial image 10B in space moves over time.

Because the position of the aerial image 10B moves although its size remains unchanged, the position of the outer edge of the aerial image 10 in the air also moves.

In FIG. 21, the aerial image 10B reproducing a cube moves from the left side to the right side of the page as time elapses (from T1 to T2, T3, T4, and to T5). That is, although the Y coordinate and the Z coordinate remain unchanged, the X coordinate changes from X1 to X2, X3, X4, and to X5.

In this case, the person 20 is able to know the passage of time through the relationship of the position of the aerial image 10B relative to the aerial image 10A.

Note that the size of the aerial image 10B may be changed over time. For example, the size may be changed to be larger or smaller.

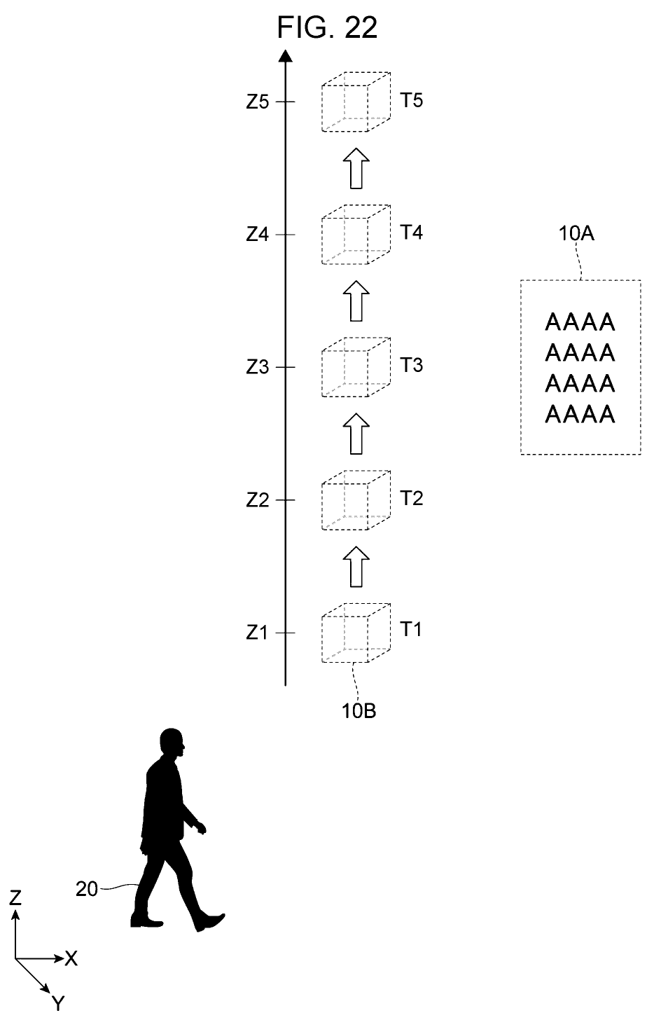

FIG. 22 is a diagram describing another example where the position of the aerial image 10B in space moves over time.

In FIG. 22, the aerial image 10B reproducing a cube moves from the bottom side to the top side of the page as time elapses (from T1 to T2, T3, T4, and to T5). That is, although the X coordinate and the Y coordinate remain unchanged, the Z coordinate changes from Z1 to Z2, Z3, Z4, and to Z5.

In this case, the person 20 is able to know the passage of time through the relationship of the position of the aerial image 10B relative to the aerial image 10A.

Note that the size of the aerial image 10B may be changed over time. For example, the size may be changed to be larger or smaller.

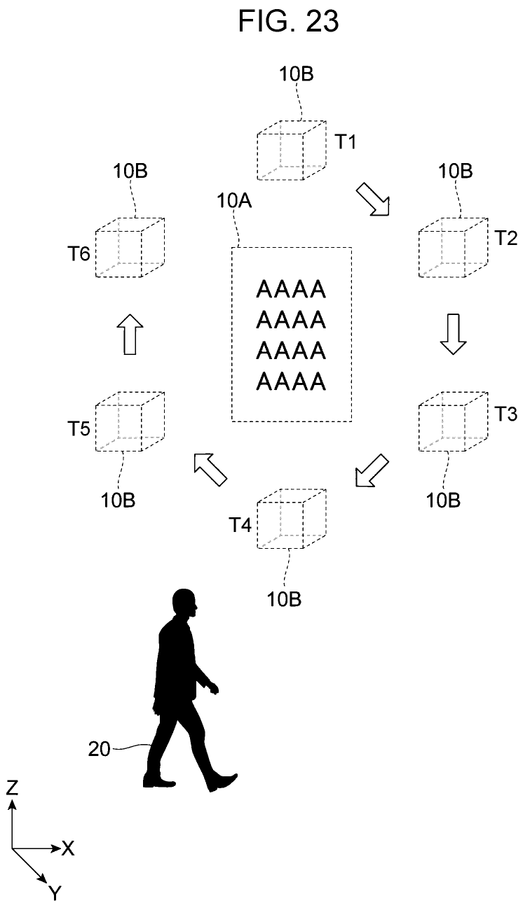

FIG. 23 is a diagram describing another example where the position of the aerial image 10B in space moves over time.

In FIG. 23, the aerial image 10B reproducing a cube moves around along the outer edge of the aerial image 10A as time elapses (from T1 to T2, T3, T4, T5, and to T6). Specifically, the aerial image 10B moves from the position of the top side of the aerial image 10A to the position of the right side, and then to the bottom side and to the left side.

In this case, the person 20 is able to know the passage of time through the relationship of the position of the aerial image 10B relative to the aerial image 10A.

Needless to say, the movement direction may be anticlockwise.

Note that the size of the aerial image 10B may be changed over time. For example, the size may be changed to be larger or smaller.

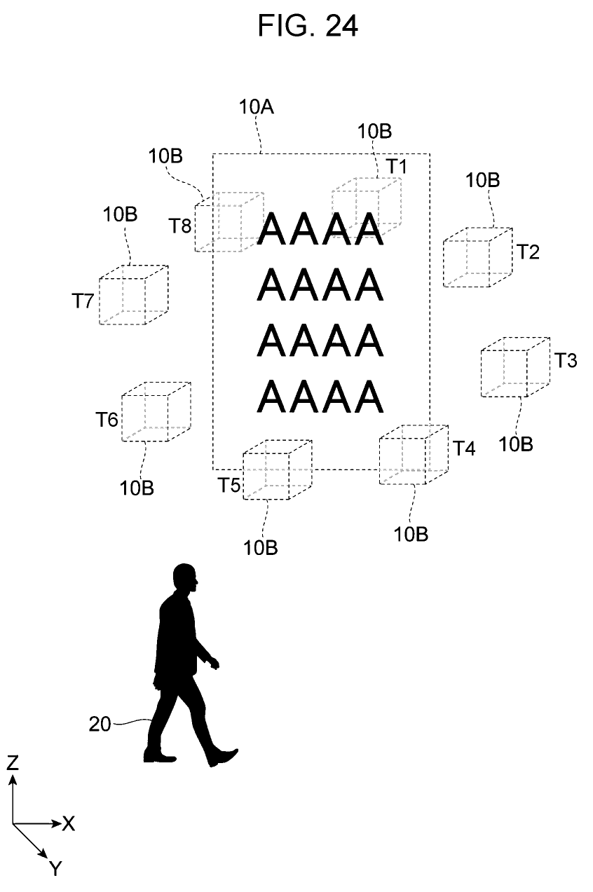

FIG. 24 is a diagram describing another example where the position of the aerial image 10B in space moves over time.

In FIG. 24, the aerial image 10B reproducing a cube moves, within the horizontal plane, around the aerial image 10A as time elapses (from T1 to T2, T3, T4, T5, T6, T7, and to T8). Specifically, the aerial image 10B moves from the back side of the aerial image 10A to the right rear position, and then to the right side, the right front, the front, the left front, the left side, and to the left rear.

In this case, the person 20 is able to know the passage of time through the relationship of the position of the aerial image 10B relative to the aerial image 10A. Because the aerial image 10A is transparent, the aerial image 10B positioned behind is identifiable.

Needless to say, the movement direction may be opposite.

Note that the size of the aerial image 10B may be changed over time. For example, the size may be changed to be larger or smaller.

### Ninth Example

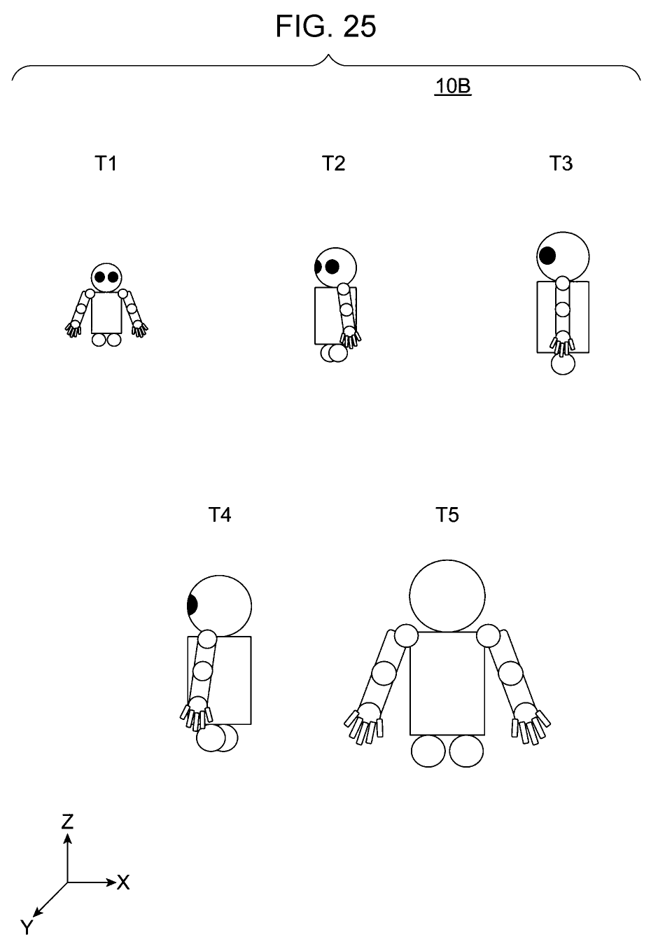

FIG. 25 is a diagram describing an example where the orientation of a target reproduced by the aerial image 10B changes over time.

In the case of FIG. 25, the aerial image 10B reproducing a robot rotates such that the orientation of the body rotates 180 degrees clockwise over time (T1 to T2, T3, T4, and T5). That is, although the position at which the aerial image 10B is formed in space remains unchanged, the orientation of the robot displayed as a planar image moves half around clockwise.

Note that, in the case of FIG. 25, the size of the aerial image 10B changes to be larger over time. Therefore, from the manner in which the size of the aerial image 10B changes to be larger, the user is able to know the approximate time since the measurement has started.

Note that the size of the aerial image 10B may change to be smaller over time.

In the case where the aerial image 10B in the exemplary embodiment is formed as a stereoscopic image (that is, in the case where the outer edge of the robot is given three-dimensionally in space), the orientation of the robot formed stereoscopically in space may be rotated.

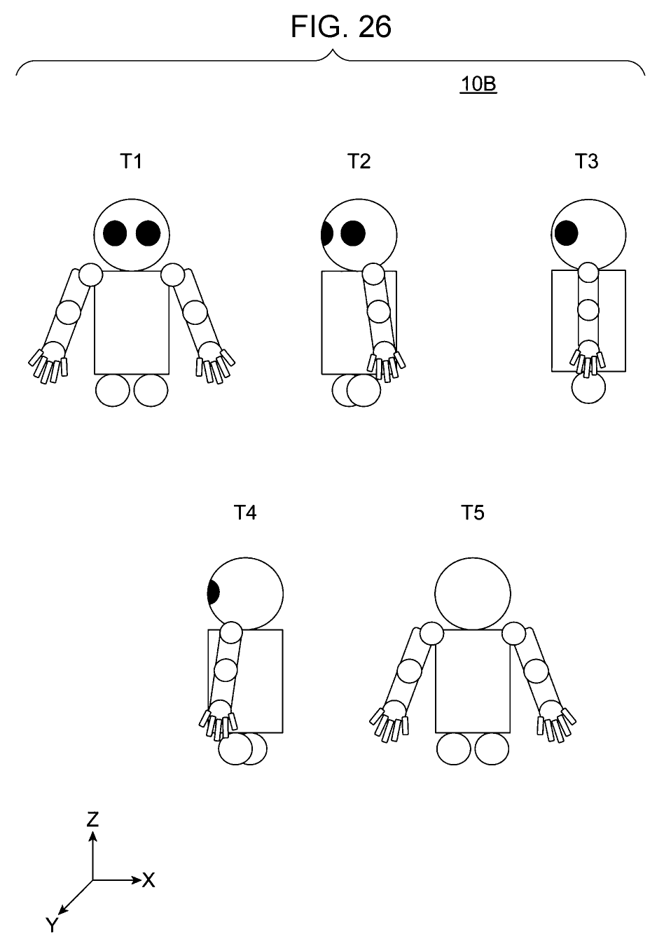

FIG. 26 is a diagram describing another example where the orientation of a target reproduced by the aerial image 10B changes over time.

In the case of FIG. 26, the aerial image 10B reproducing a robot rotates such that the orientation of the body rotates 180 degrees clockwise over time (T1 to T2, T3, T4, and T5) while the size of the aerial image 10B remains unchanged.

In this case, from the orientation of the robot, the user is able to know the approximate time since the measurement has started.

For example, in the case of reproducing a spherical surface like a globe, the user may be notified of the passage of time by forming the aerial image 10B viewed to move in the direction of a landmark on the spherical surface.

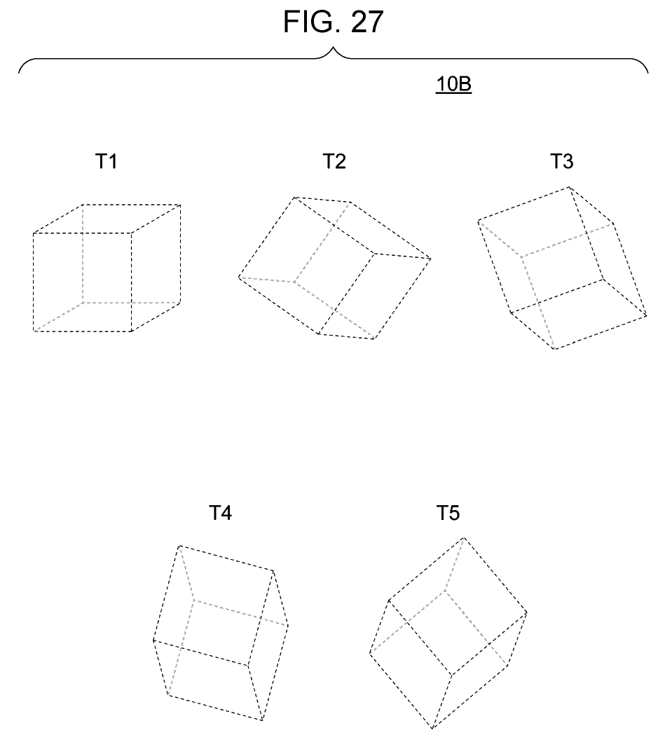

In any case, the aerial image 10B may rotate once. FIG. 27 is a diagram describing another example where the orientation of a target reproduced by the aerial image 10B changes over time.

Although the manner in which the robot rotates half around a rotation axis has been illustrated in FIGS. 25 and 26, the rotation may be done three-dimensionally.

In FIG. 27, the orientation of a cube reproduced by the aerial image 10B changes three-dimensionally over time (T1 to T2, T3, T4, and to T5). In this case, if the order of appearance of changes in orientation is known, the user is able to know the time elapsed from the orientation of the aerial image 10B.

### Tenth Example

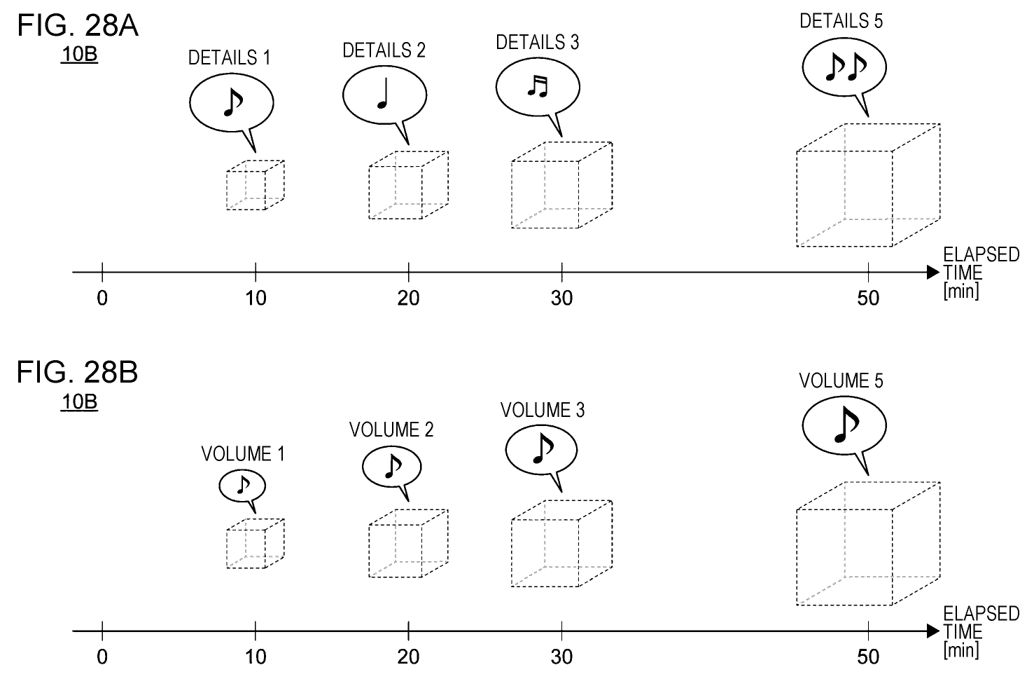

FIGS. 28A and 28B are diagrams describing an example where the details and volume of sound that accompanies the aerial image 10B change over time. FIG. 28A illustrates an example where the details of the sound change over time, and FIG. 28B illustrates an example where the volume of the sound changes over time.

Note that, in FIGS. 28A and 28B, the size of the aerial image 10B changes to be larger over time. Needless to say, the size of the aerial image 10B may change to be smaller over time. The size of the aerial image 10B may remain unchanged as long as there are changes in the details or volume of the sound. In that case, the position of the outer edge of the aerial image 10B may change.

Although the volume of the sound becomes greater over time in FIG. 28B, the volume of the sound may become smaller.

In the case of FIGS. 28A and 28B, the size in increments of ten minutes is illustrated; however, the size may be changed at predetermined time intervals (such as one second, five seconds, ten seconds, thirty seconds, one minute, two minutes, etc.).

### Eleventh Example

Although the above-described exemplary embodiment assumes the case where the aerial image forming apparatus 312 is basically a non-portable apparatus, the aerial image forming apparatus 312 may be provided in a highly portable apparatus.

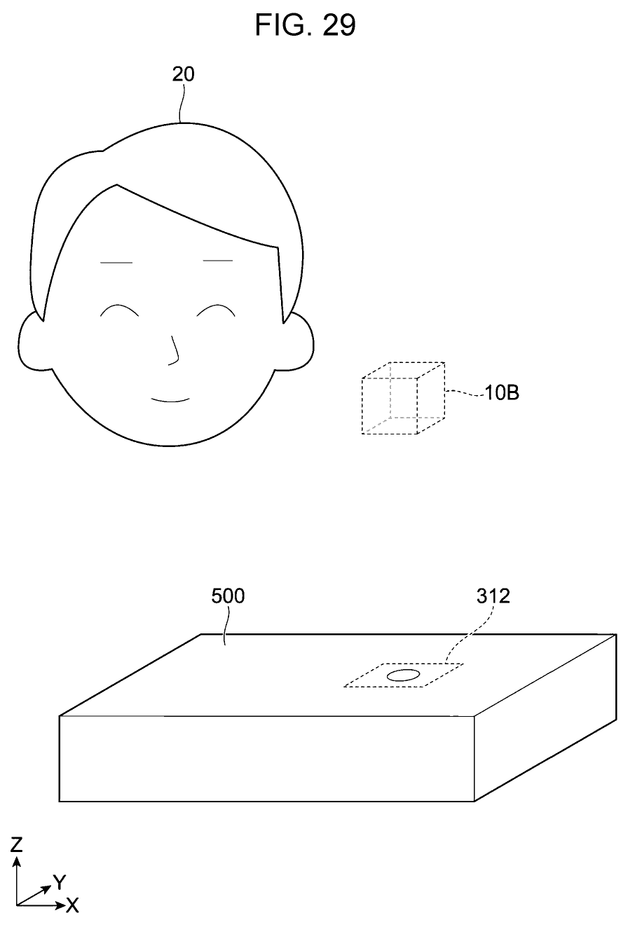

FIG. 29 is a diagram describing a portable information processing apparatus 500 including the aerial image forming apparatus 312. The information processing apparatus 500 is assumed to be carried by the person 20.

The information processing apparatus 500 in FIG. 29 includes an apparatus placed and used at an arbitrary location such as on a desk or on the floor, besides a notebook computer, a smartphone, a game machine, or an electronic dictionary.

As the aerial image forming apparatus 312 here, for example, an apparatus that forms the aerial image 10B as a set of plasma emitters (see FIG. 7) is used.

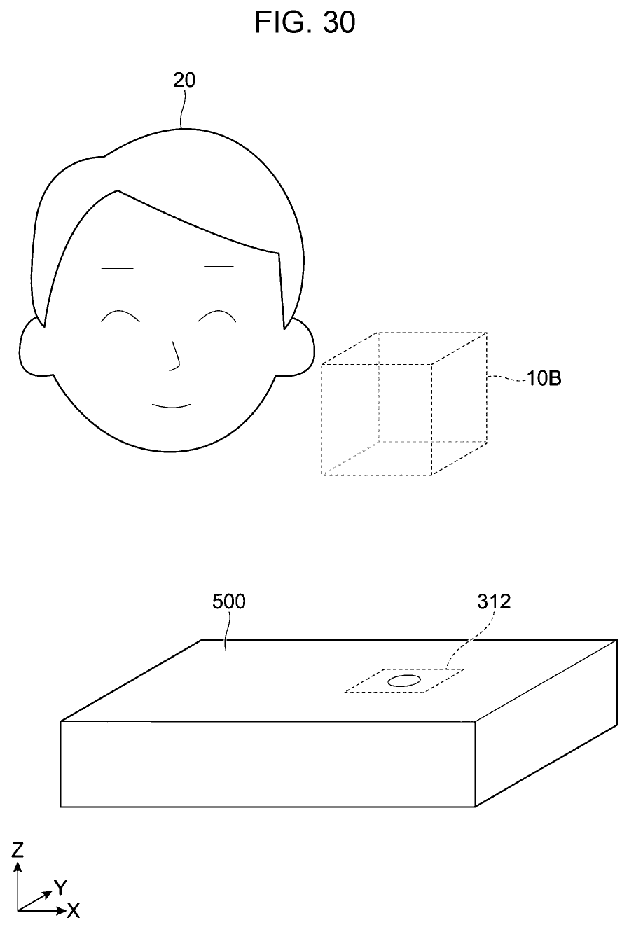

FIG. 30 is a diagram describing a change in the size of the aerial image 10B formed by the portable information processing apparatus 500 over time.

By enlarging the distance between coordinates for rendering light points over time, the volume of the cube may be changed to be greater over time.

Although the case of forming a stereoscopic image is assumed in FIGS. 29 and 30, a planar image may be formed.

### Other Exemplary Embodiments

Although the exemplary embodiment of the present invention has been described as above, the technical scope of the present invention is not restricted to the range described in the exemplary embodiment. It is clear from the scope of claims that various changes or modifications added to the exemplary embodiment are also included in the technical scope of the present invention.

For example, although the aerial image forming apparatuses 311 and 312 are independent apparatuses in the above-described embodiment, they may be one apparatus. For example, in the case of the aerial image forming apparatus 31E (see FIG. 7), which adopts the method of forming an image of points to which light is plasma-emitted in the air, both the aerial images 10A and 10B may be formed using one apparatus.

Although the image control apparatus 32 is described as an apparatus independent of the aerial image forming apparatuses 311 and 312 in the above-described embodiments, the image control apparatus 32 may be integrated with the aerial image forming apparatus 311 (or 312).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a controller that changes an outer edge of an image formed in air over time.

2. The information processing apparatus according to claim 1, wherein the outer edge becomes larger or smaller over time.

3. The information processing apparatus according to claim 1, wherein a form of a target reproduced by the image changes over time.

4. The information processing apparatus according to claim 3, wherein the form of the target grows over time.

5. The information processing apparatus according to claim 3, wherein the form of the target regresses over time.

6. The information processing apparatus according to claim 1, wherein a target reproduced by the image is switched.

7. The information processing apparatus according to claim 1, wherein a posture of a target reproduced by the image is switched.

8. The information processing apparatus according to claim 1, wherein the image changes according to a predetermined story.

9. The information processing apparatus according to claim 1, wherein a position of the outer edge moves in space while a size of the image remains unchanged.

10. The information processing apparatus according to claim 1, wherein an orientation of the outer edge changes while a size of the image remains unchanged.

11. The information processing apparatus according to claim 1, wherein details of sound or a volume of sound changes.

12. A non-transitory computer readable medium storing a program causing a computer to execute a process, the process comprising changing an outer edge of an image formed in air over time.

13. An information processing apparatus comprising:
control means for changing an outer edge of an image formed in air over time.
